(19) United States
(12) Patent Application Publication
(10) Pub. No.: US 2001/0039192 A1
(43) Pub. Date: Nov. 8, 2001

(54) Time synchronization of radio networks

(76) Inventors: Jacob Kristian Osterling, Stockholm (SE); Dan Anders Lindqvist, Sollentuna (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/766,616

(22) Filed: Jan. 23, 2001

Related U.S. Application Data
(60) Provisional application No. 60/177,656, filed on Jan. 27, 2000.

(51) Int. Cl. H04B 15/00

(52) U.S. Cl. 455/502; 455/456; 455/561

(57) ABSTRACT

Methods and apparatus are provided for maintaining an accurate clock in a base transceiver station. Location measurement units which are used for determining the location of mobile stations is used to provide the current global positioning satellite (GPS) time to the base transceiver station. The base transceiver station can then adjust its own clock based upon the current GPS time. When the message in a GPS signal cannot be decoded the location measurement unit can determine the current GPS time by decoding the chip sequence of the GPS signal.

### BACKGROUND

The present invention relates generally to radiocommunication networks and, more particularly, to a method and apparatus for time synchronization of base transceiver stations in a radiocommunication network.

The growth of commercial communication networks and, in particular, the explosive growth of cellular radiotelephone networks, have compelled network designers to search for ways to increase network capacity without reducing communication quality beyond consumer tolerance thresholds. One method for increasing network capacity is through time synchronization of base transceiver stations (BTS). For example, in a system which operates according to the Global System for Mobile Communications (GSM) standards, BTSs communicate with mobile stations using a frequency hopping transmission scheme. If BTSs are unsynchronized in a GSM system there is a chance that two or more BTSs may simultaneously transmit on a particular frequency in the frequency hopping scheme. If these two or more BTSs are located such that a mobile station can receive signals from these two or more BTSs, a collision will result when these BTSs simultaneously transmit on the same frequency in the frequency hopping sequence. If the BTSs are time synchronized, the radio network can control the frequency hopping sequences used by each BTS such that each BTS does not simultaneously transmit on a particular frequency in the frequency hopping sequence as another BTS which is within the frequency reuse distance of the particular BTS.

One method proposed for synchronizing BTSs is to place a mobile station in the antenna mast of each BTS. These mobile stations would measure the co-sited BTSs timing relative to other BTSs by measuring the broadcast control channel (BCCH) transmitted from the co-sited and surrounding BTSs. A BTS would then adjust its own time source based upon the measurements of the BTS's own BCCH relative to other BTSs' BCCH. However, this solution requires support from a base station controller (BSC), which increases the load on the network. Further, this solution takes a long time to synchronize the timing of BTS. In addition, this solution depends upon the radio environment between different BTSs which may be subject to multipath propagation of the transmitted BCCHs.

In GSM systems, each BTS maintains its own reference time known as GSM time. In conventional BTSs the GSM time is started when a BTS is installed. The current GSM time of any particular BTS can be determined using the current frame number transmitted from a BTS. Since each BTS transmits one frame each predetermined time period, the current GSM time of a particular BTS is determined by multiplying the current frame number by the predetermined time period. However, there is no common reference time between BTSs currently implemented in a GSM network. Accordingly, the mobile station in the antenna mast of each BTS solution requires each BTS to determine a relationship between the GSM time of a particular BTS and the BTSs' own GSM time. Further, since there is no common reference time currently available in a GSM system a BTS can only adjust its GSM time in relation to the most accurate timing source in the network, which may not necessarily be an accurate timing source. In addition, due to a lack of a common time reference a particular BTS in accordance with this solution can determine if there is a clock drift between two BTSs, but a particular BTS cannot determine which BTSs' clock is drifting.

Another solution for synchronizing BTSs is through the use of a global positioning satellite (GPS) receiver in each BTS. Since the GPS system requires very accurate timing in order to provide accurate position location, a GPS receiver maintains a very accurate internal clock. In accordance with this solution the GPS receiver is connected to the timing unit (DXU) of a BTS. The DXU contains a timing unit which holds the GSM time for the BTS. However, this requires the BTS to have a GPS interface. However, BTSs currently installed in networks do not have a GPS interface.

Due to governmental regulations relating to mobile station position location in emergency situations, location measurement units (LMU) are being installed in BTSs. An LMU is essentially a mobile station. Two currently standardized location mechanisms are known as enhanced observed time difference (E-OTD) and assisted GPS (AGPS). AGPS positioning uses an LMU with an integrated GPS receiver.

FIG. 1 illustrates a conventional radio network which implements an LMU. The radio network illustrated in FIG. 1 includes a GPS satellite 105, BTSs 110, 120 and 130, LMUs 115, 125, 135, a base station controller (BSC) 140, a mobile switching center/visitor location register (MSC/VLR) 145, a serving mobile location center (SMLC) 150, a cell data base 155, a GPS data base 160, a GPS receiver 165, and a mobile station 170.

To implement E-OTD in a network such as that illustrated in FIG. 1, mobile station 170 measures the relative time of arrival of signals from BTSs 110, 120 and 130. LMU 115 also measures the relative time of arrival of signals transmitted from BTSs 110, 120 and 130. To obtain accurate triangulation in a non-synchronized network, the network needs to determine the realtime differences (RTD) between the transmission frames transmitted from BTSs 110, 120 and 130. The RTD is the relative time synchronization difference in the network between two BTSs, e.g., the RTD is used to determine exactly when a particular received burst was transmitted from a BTS.

Using the known position of LMU 115 and BTSs 110, 120 and 130 in conjunction with the time at which LMU 115 received transmitted frames from BTSs 110, 120 and 130, SMLC 150 can determine the RTDs between the bursts transmitted from BTSs 110, 120 and 130. SMLC 150 then uses reports from mobile station 170 as to when mobile station 170 received the bursts transmitted from BTSs 110, 120 and 130, in conjunction with the previously determined RTDs, to triangulate the position of mobile station 170. For more information as to the use of LMUs and the determination of E-OTD the interested reader should refer to GSM ETSI TS 101 724 V7.2.2.1 “Digital Cellular Telecommunication System (base 2+); Location Services (LCS); (functional description) - stage 2 (GSM03.71 version 7.2.1 released 1998)”, which is herein expressly incorporated by reference.

To implement AGPS in a network such as that illustrated in FIG. 1, LMUs, e.g., LMU 115, measures the timing of one of more BTSs, e.g., BTS 110 and 120, and relates the respective timings to the GPS time received from GPS satellite 105. The LMU communicates this information, using standard protocols, to SMLC 150. The SMLC 150 can then provide the collected timing information for a BTS which serves a GPS mobile station to the GPS mobile station.

For example, SMLC 150 will provide the timing for BTS 110 to GPS mobile station 170. The mobile station then examines the frame number transmitted from the serving BTS and calculates GPS time based on the frame number and the timing information provided by the SMLC. This GPS time is provided to the GPS receiver in the mobile station which then examines the chip sequence received from each satellite within sight, which typically is at least four satellites. Using the phase of the chip sequence received from the four satellites the mobile station triangulates its position and determines the exact GPS time. It will be recognized that if the SMLC had not provided the GPS mobile station with the timing information, the GPS mobile station would have had to decode the time information in the GPS messages sent from the GPS satellites. The decoding of these messages requires a greater carrier-to-noise ratio than that required to examine the chip sequences received from the satellites.

However, the LMU is currently only being used for position location of mobile stations. It would be desirable to use an LMU for both position location in mobile stations and time synchronization of BTSs. In addition, GPS may become unavailable if satellites are malfunctioning or if severe weather occurs. Moreover, if sky visibility is limited for a GPS receiver, enough satellites are not always visible for position location and synchronization. In addition, GPS receivers cannot be used indoors due to high path loss. Currently the only way to implement a GPS receiver indoors is to place the GPS receiver outdoors and run long cable lines indoors. Accordingly, it would be desirable to provide a method for maintaining synchronization when GPS is not available. Further, it would be desirable to provide synchronization to GPS time for indoor installations of radio networks. In addition, it would be desirable to limit the number of LMUs located throughout a radio network.

### SUMMARY

These and other problems, drawbacks and limitations of conventional techniques are overcome according to the present invention by a method and apparatus for adjusting the clock of a base transceiver station. The base transceiver station's current time is related to a common time reference. The base transceiver station is provided with an offset based on the relation. The base transceiver station's clock is then adjusted based on the offset. In accordance with one embodiment of the present invention, the common time reference is global positioning satellite (GPS) time.

In accordance with one aspect of the present invention the time of base transceiver stations surrounding the base transceiver station and the time of the base transceiver station's clock are measured. In accordance with this aspect of the present invention the time of base transceiver stations surrounding the base transceiver station and the time of the base transceiver station's clock are measured using a frame number transmitted from the base transceiver stations surrounding the base transceiver station and the base transceiver station.

In accordance with another aspect of the present invention the base transceiver station is provided with information from a location measurement unit, wherein the base transceiver station's clock is adjusted based upon the information from the location measurement unit.

In accordance with yet another aspect of the present invention GPS time is determined and compared to the time of the base transceiver station's clock, wherein the base transceiver station's clock is adjusted based upon the offset and the comparison.

### BRIEF DESCRIPTION OF THE DRAWINGS

The objects and advantages of the invention will be understood by reading the following detailed description in conjunction with the drawings in which:

FIG. 1 illustrates a conventional radio network which implements location services;

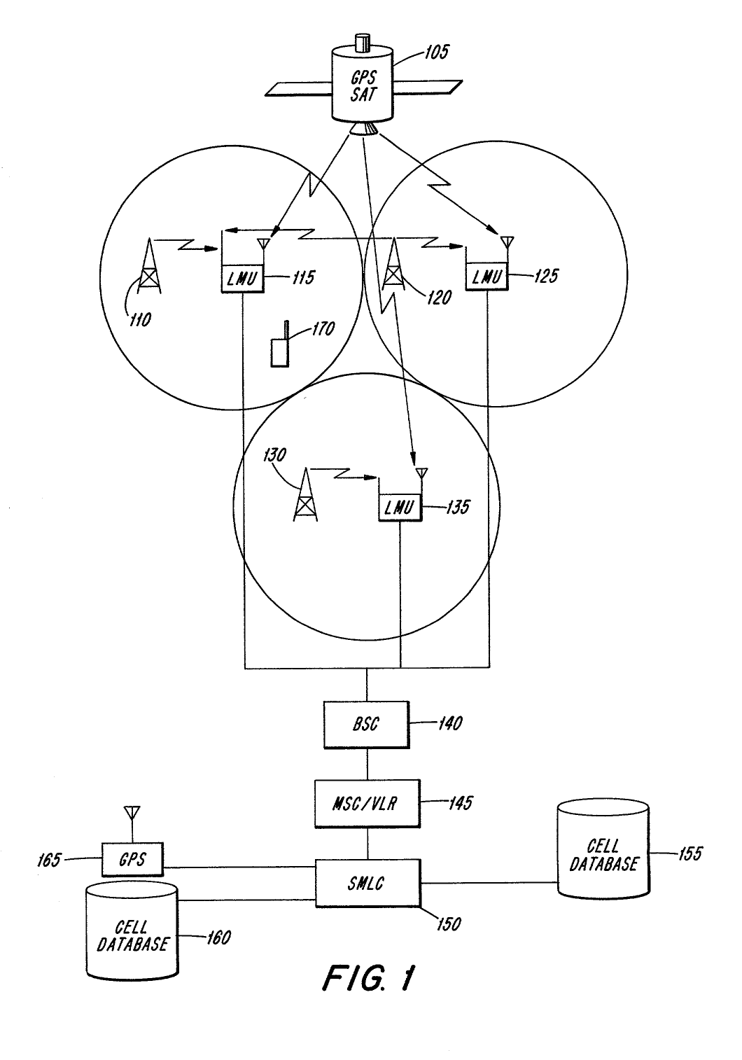

FIG. 2 illustrates a radio network which uses elements of the radio network's location services for time synchronization of BTSs;

FIG. 3 illustrates the relationship between a serving mobile location center, a location measurement unit, a base transceiver station and a mobile station in accordance with exemplary embodiments of the present invention;

FIG. 4 illustrates a method for local time synchronization of BTSs in accordance with exemplary embodiments of the present invention; and

FIG. 5 illustrates a method for time synchronization of BTSs using a serving mobile location center in accordance with exemplary embodiments of the present invention.

### DETAILED DESCRIPTION

The present invention is directed to radio networks which implement location services. Specifically, the present invention uses elements which are conventionally used only for location services for time synchronization of the radio network.

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the present invention.

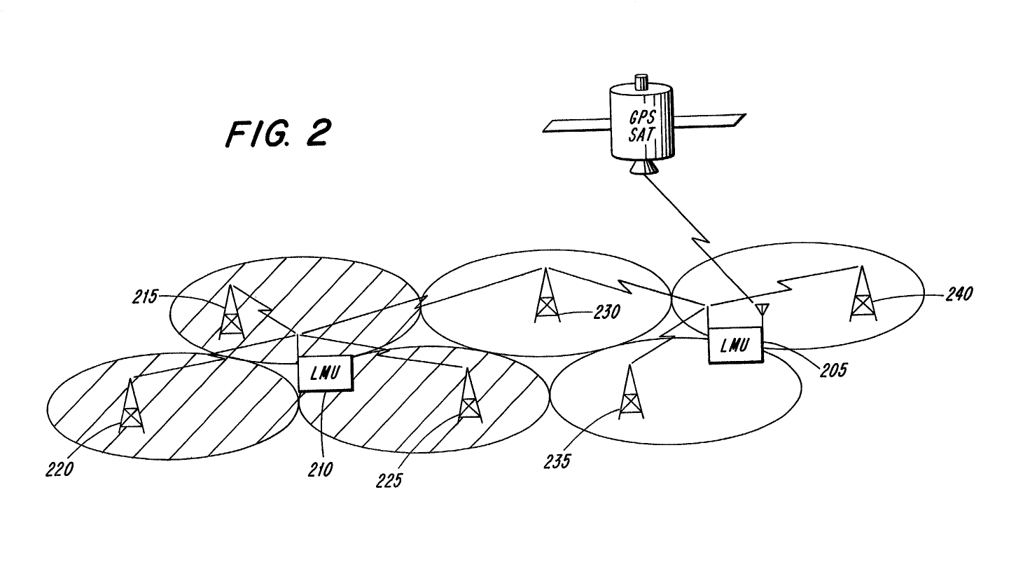

FIG. 2 illustrates a radio network in accordance with exemplary embodiments of the present invention. The radio network comprises LMUs 205 and 210, BTSs 215-240, and GPS satellite 245. As illustrated in FIG. 2, in accordance with the present invention it is not necessary for each BTS to contain its own LMU. Further, each LMU does not require an integrated GPS receiver. In accordance with the present invention, LMU 205 measures both GPS time as received from GPS satellite 245 and the GSM time of BTSs 230, 235 and 240. LMU 205 measures the GSM time of BTSs 230, 235 and 240 by measuring the frame number transmitted over the BCCH of the BTSs and the time at which the LMU receiver a particular frame. LMU 205 provides BTSs 230, 235 and 240 with data that indicates the drift in GSM time of a particular BTS relative to the GPS time received from GPS satellite 245.

By synchronizing BTS 230 to GPS time, via LMU 205 and GPS satellite 245, LMU 210 does not require a GPS receiver because LMU 210 can use the GSM time of BTS 230 as a reference time. LMU 210 uses the GSM time of BTS 230 because it is assumed that BTS 230 maintains an accurate time due to its synchronization via LMU 205 with GPS time. Accordingly, LMU 210 can synchronize BTSs 215, 220 and 225 using the measured timing from BTS 230.

In accordance with exemplary embodiments of the present invention, if LMU 205 loses the ability to measure GPS time, LMU 205 will synchronize BTSs 235 and 240 to the GSM time of BTS 230. In addition, LMU 210 will synchronize BTSs 215, 220 and 225 using the GSM time of BTS 230. This ensures that the BTSs maintain synchronization relative to each other. Alternatively, an SMLC, not illustrated, can evaluate the measurements from the different LMUs and calculate correction values for each BTS which are then sent to the corresponding BTSs. In addition, the GSM time of BTS 230 can be used to synchronize other equipment co-sited with the LMU, e.g., a WCDMA BTS. Further, since the GSM time of BTS 230 has a relationship to GPS time, BTS 230 can be used as a time base for AGPS positioning without requiring additional processing from the SMLC.

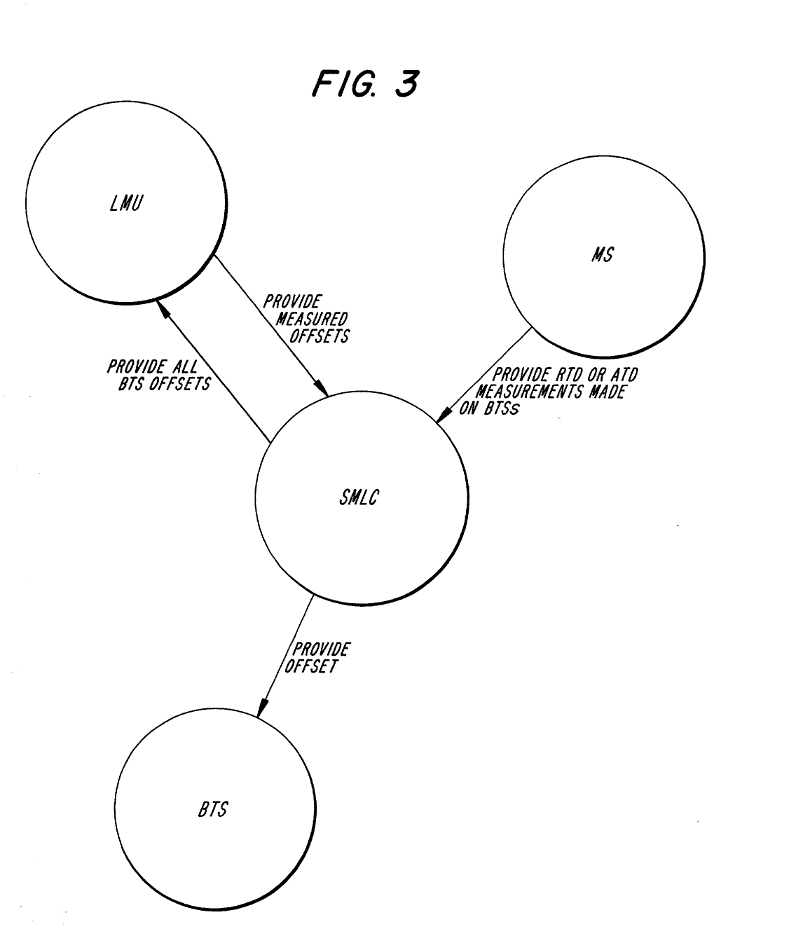

FIG. 3 illustrates the relationship between a SMLC, a LMU, a BTS and a mobile station in accordance with exemplary embodiments of the present invention. Since each BTS maintains its own GSM time independently, a relationship between each BTS's GSM time and GPS time should be determined. Once the relationship between each BTS's GSM time and GPS time is determined, the relationship can be used to adjust the GSM time of a particular BTS to achieve a desired offset. Accordingly, each LMU measures the timing of surrounding BTSs and relates these measured timings to the beginning of the GPS time. The beginning of GPS time was on Jan. 6, 1980. Accordingly, each LMU, counts backwards from the current frame number a predetermined amount of time, based upon the timing between transmitted frames, until it reaches Jan. 6, 1980. The LMUs report the difference between each BTSs' own GSM time and the beginning of GPS time to the SMLC. The SMLC using the measured differences received from LMUs provides each LMU with the timing offsets of all of the BTSs which the SMLC serves.

Another method for obtaining the estimate of the offset of a particular BTS's time involves a mobile station performing E-OTD positioning. As illustrated in FIG. 3, mobile stations can provide real time difference or arrival time difference measurements made on BTSs to the SMLC. These measurements are then used by the network, e.g., the SMLC, to determine the difference in transmission time between different BTSs. If one of the BTSs is locked by an LMU, the offset of the other BTS's times can be determined and fed to one or more LMUs. If no BTS is locked to an LMU, an AGPS mobile station can be asked to deliver the burst arrival time of one of the bursts received by a BTS. The burst arrival time provides an error equal to an propagation delay between the BTS and the mobile station which provides a very good estimate of the offset time.

In addition, the SMLC provides each of the BTSs with a desired offset This offset value is selected by the SMLC such that BTSs which are within radio range of each other do not attempt to transmit over the same frequency in a frequency hopping sequence at the same time. These offset values may be reused in accordance with known frequency reuse patterns.

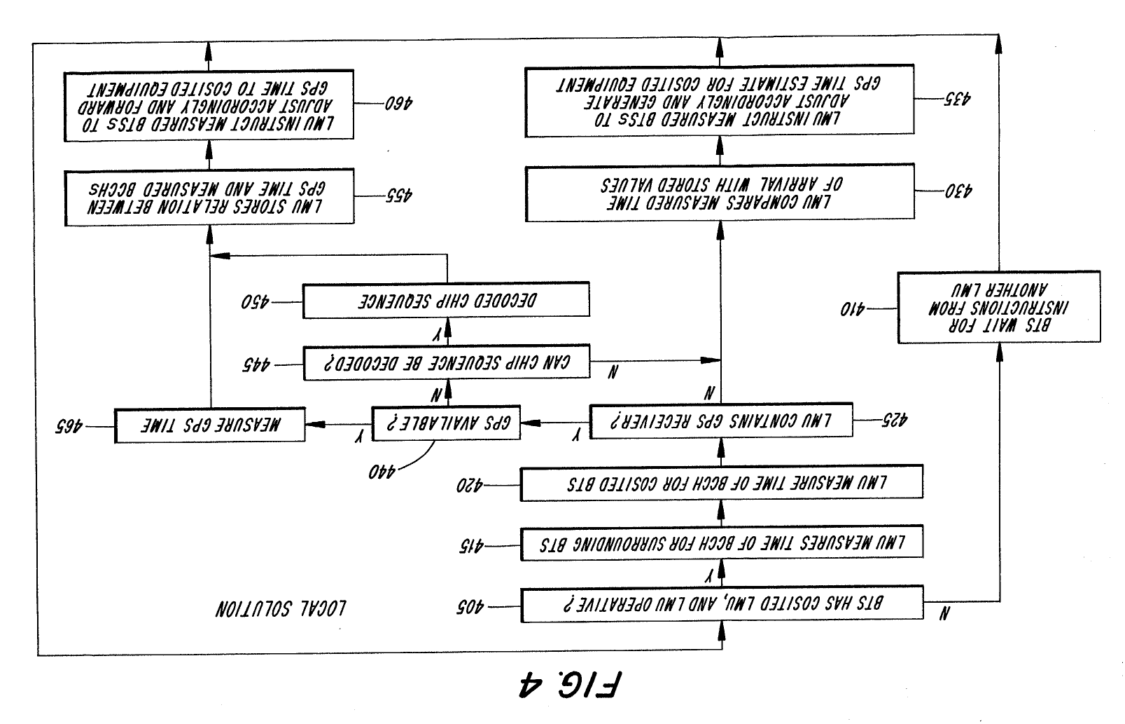

FIG. 4 illustrates a method for synchronization of BTSs in accordance with exemplary embodiments of the present invention. Initially, it is determined whether the BTS has a co-sited LMU and whether the LMU is operative (step 405). If the BTS does not have a co-sited LMU or if the co-sited LMU is not operative (“No” path out of decision step 405), the BTS waits for instructions from another LMU as to how to adjust the BTS's internal clock (step 410). It will be recognized that other LMUs associated with other BTSs will also be measuring the BCCH of the particular BTS and can determine the drift of this particular BTS's GSM time. When the particular BTS receives the instructions it adjusts its GSM time in accordance with the instructions. This process is repeated as indicated in FIG. 4 by the return path from step 410 to step 405.

If the BTS has an operative co-sited LMU (“Yes” path out of decision step 405), the LMU measures the time of receipt of frames transmitted over BCCHs associated with BTSs surrounding the cell in which the LMU is currently located (step 415). The LMU then measures the time of receipt of frames transmitted over the BCCH associated with the co-sited BTS (step 420). Next, it is determined whether the LMU contains a GPS receiver (step 425). If the LMU does not contain a GPS receiver (“No” path out of decision step 425) the LMU compares the measured time of arrival of the co-sited BCCH with stored values (step 430). These stored values are a relation between GPS time and the GSM time of the BTSs. These stored values can be provided to the LMU from an LMU with a GPS receiver. The LMU then instructs the measured BTSs to adjust their time in accordance with the comparison and the LMU generates a GPS time estimate for the co-sited equipment (step 435). This process is repeated as indicated in FIG. 4 by the return path from step 435 to step 405.

In accordance with exemplary embodiments of the present invention improved time synchronization can be obtained by BTSs transmitting information as to the accuracy of their own clock. For example, BTSs can transmit system information in the BCCH. This system information can indicate if the BTS is GPS synchronized, remotely synchronized to an LMU which is synchronized to GPS, not synchronized but the BTS uses a highly stable oscillator, and not synchronized and the BTS uses a conventional oscillator. This type of system information allows an LMU to weigh the measurements from surrounding BTSs so that a BTS can synchronize itself to a BTS which uses a very accurate timing reference. In addition, the system can be configured by the network operator to indicate which BTS to use as a time reference during network planning. Alternatively, an indication as to which BTS to use as a timing reference can be provided by an SMLC based upon alarms and information regarding BTSs collected from different LMUs.

If the LMU does contain a GPS receiver (“Yes” path out of decision step 425) the LMU determines whether the messages of the GPS signal can be decoded (step 440). If it is determined that the GPS messages cannot be decoded (“No” path out of decision step 440) then the LMU determines whether the phase of the chip sequence of the GPS signal can be decoded (step 445). If the LMU cannot decode the phase of the chip sequence of the GPS signal (“No” path out of decision step 445) the LMU compares the measured time of arrival of the co-sited BCCH with stored values (step 430). When an LMU has a GPS receiver, but it cannot currently receive the GPS time from the GPS satellites, the stored values can be a relationship between GPS time and GSM time of the BTSs which was stored when GPS was available for the LMU. The LMU then instructs the measured BTSs to adjust their time in accordance with the comparison and the LMU generates a GPS time estimate for the co-sited equipment (step 435). This process is repeated as indicated in FIG. 4 by the return path from step 435 to step 405.

If the LMU can decode the phase of the chip sequence of the GPS signal (“Yes” path out of decision step 445) then the LMU decodes the chip sequence to determine GPS time (step 450) and stores a relation between GPS time and the GSM time of the measured BCCHs (step 455). The LMU then instructs the measured BTSs to adjust their time accordingly and the LMU forwards the GPS time to co-sited equipment (step 460). This process is repeated as indicated in FIG. 4 by the return path from step 460 to step 405.

If GPS time is available (“Yes” path out of decision step 440) the LMU measures the GPS time using the received GPS messages (step 465). The LMU then stores a relation between GPS time and the GSM time of the measured BCCHs (step 455). The LMU then instructs the measured BTSs to adjust their time accordingly and the LMU forwards the GPS time to co-sited equipment (step 460). This process is repeated as indicated in FIG. 4 by the return path from step 460 to step 405.

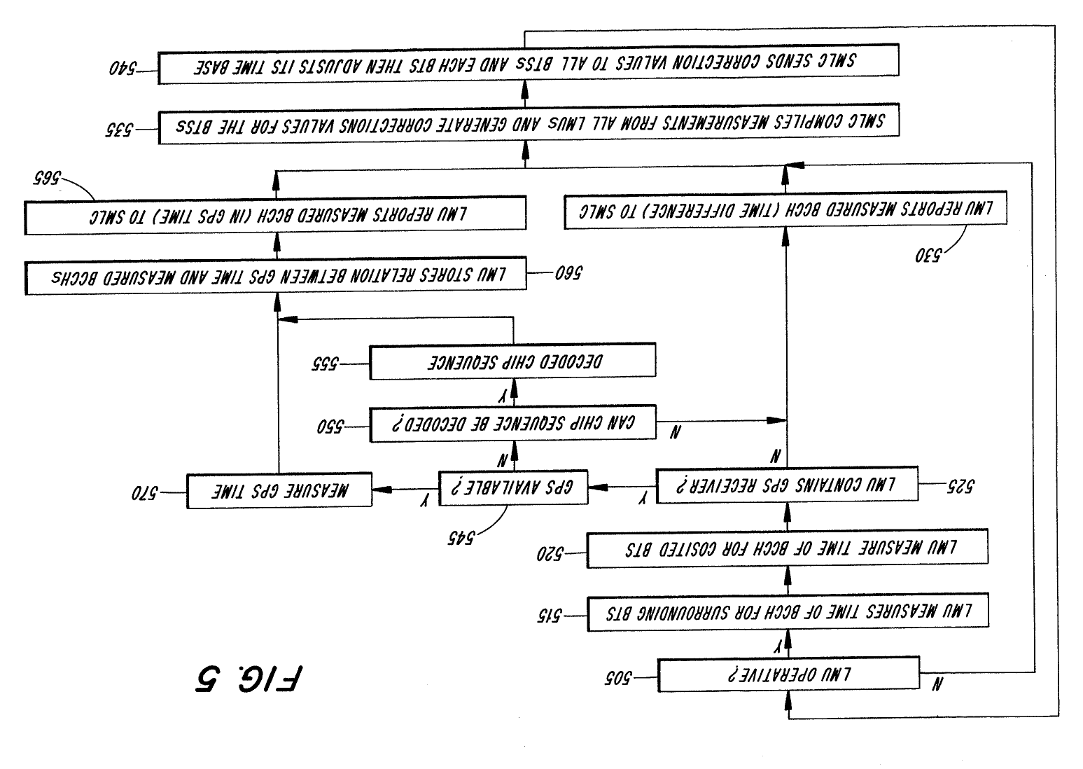

FIG. 5 illustrates a method for synchronization of BTSs in accordance with exemplary embodiments of the present invention. In accordance with this embodiment, an SMLC is used in the time synchronization process. Initially, it is determined whether the BTS has a co-sited LMU and whether the LMU is operative (step 505). If the BTS does not have a co-sited LMU or if the co-sited LMU is not operative (“No” path out of decision step 505), the SMLC then compiles measurements from all LMUs and generates correction values for the BTSs (step 535). Next the SMLC sends the correction values to all BTSs and each BTS then adjusts its time base (step 540). This process is repeated as indicated in FIG. 5 by the return path from step 540 to step 505.

If the BTS has an operative co-sited LMU (“Yes” path out of decision step 505), the LMU measures the time of receipt of frames transmitted over BCCHs associated with BTSs surrounding the cell in which the LMU is currently located (step 515). The LMU then measures the time of receipt of frames transmitted over the BCCH associated with the co-sited BTS (step 520). Next, it is determined whether the LMU contains a GPS receiver (step 525). If the LMU does not contain a GPS receiver (“No” path out of decision step 525) the LMU reports the measured BCCH time differences between the co-sited BTS and the surrounding BTSs to the SMLC (step 530). The SMLC then compiles measurements from all LMUs and generates correction values for the BTSs (step 535). Next the SMLC sends the correction values to all BTSs and each BTS then adjusts its time base (step 540). This process is repeated as indicated in FIG. 5 by the return path from step 540 to step 505.

If the LMU does contain a GPS receiver (“Yes” path out of decision step 525) the LMU determines whether the messages of the GPS signal can be decoded (step 545). If it is determined that the GPS messages cannot be decoded (“No” path out of decision step 545) then the LMU determines whether the phase of the chip sequence of the GPS signal can be decoded (step 550). If the LMU cannot decode the phase of the chip sequence of the GPS signal (“No” path out of decision step 550) the LMU reports the measured BCCH time differences between the co-sited BTS and the surrounding BTSs to the SMLC (step 530). The SMLC then compiles measurements from all LMUs and generates correction values for the BTSs (step 535). Next the SMLC sends the correction values to all BTSs and each BTS then adjusts its time base (step 540). This process is repeated as indicated in FIG. 5 by the return path from step 540 to step 505.

If the LMU can decode the phase of the chip sequence of the GPS signal (“Yes” path out of decision step 550) then the LMU decodes the chip sequence to determine GPS time (step 555) and stores a relation between GPS time and the GSM time of the measured BCCHs (step 560). The LMU then reports the measured BCCH in GPS time to the SMLC (step 565). The SMLC then compiles measurements from all LMUs and generates correction values for the BTSs (step 535). Next the SMLC sends the correction values to all BTSs and each BTS then adjusts its time base (step 540). This process is repeated as indicated in FIG. 5 by the return path from step 540 to step 505.

If GPS time is available (“Yes” path out of decision step 545) the LMU measures the GPS time using the received GPS messages (step 570). The LMU then stores a relation between GPS time and the GSM time of the measured BCCHs (step 560). The LMU then reports the measured BCCH in GPS time to the SMLC (step 565). The SMLC then compiles measurements from all LMUs and generates correction values for the BTSs (step 535). Next the SMLC sends the correction values to all BTSs and each BTS then adjusts its time base (step 540). This process is repeated as indicated in FIG. 5 by the return path from step 540 to step 505.

It will be recognized that exemplary embodiments of the present invention allow a BTS to maintain synchronization even when the co-sited LMU cannot decode the messages transmitted from a GPS. For example, a BTS which is located indoors, and hence its LMU receives a GPS signal with a very high path loss, may be able to determine the phase of the chip sequence of the GPS signal (step 445 or 550). So that the LMU can decode the chip sequence from the GPS satellite, GPS assistance data can be provided to the LMU either via short message service (SMS) messages or via a wired connection. The assistance data includes information about the relationship between GPS time and GSM time for the co-sited, or another closely located, BTS. This information is used by the LMU to obtain an accurate time to start from for decoding the chip sequence. This LMU can then decode the chip sequence to determine the GPS time (step 450 or 555). The BTSs time are then adjusted based upon a comparison of the GSM time of the co-sited BTS (step 455 and 460). Alternatively, the BTSs time can be adjusted based upon correction values received from the SMLC (step 540).

In accordance with the present invention the number of LMUs placed throughout the network used for synchronization can be decreased by implementing interference rejection techniques in the LMU. Since the LMU is typically implemented in the mast of a BTS antenna the LMU will be able to receive BCCHs transmitted from many more BTSs than a mobile station located on the ground. The ability of the LMU to receive many BCCHs results in a decreased carrier to interference ratio which reduces the LMUs ability to decode the frame number received from any particular BTS. In accordance with exemplary embodiments of present invention, the SMLC can provide the LMU with an estimate of the offset of a particular BTS's time. Accordingly, an LMU will not have to decode the frame number received from a particular BTS. Instead, an LMU will only need to perform a correlation on the training sequence received from a particular BTS using, for example, the Synchronization Channel (SCH). The SCH is an extra long burst with a very robust training sequence which is sent approximately every 0.1 seconds. Since training sequences are designed to be relatively robust, the training sequences can be decoded in very noisy environments.

In accordance with one embodiment of the present invention, the LMU can be called by the BTS, e.g., over the air interface, to provide the current GPS time or relationship between GPS and GSM time for the BTS. Alternatively, the LMU can place regular calls to the BTS to provide this information.

The present invention has been described with reference to several exemplary embodiments. However, it will be readily apparent to those skilled in the art that it is possible to embody the invention in specific forms other than those of the exemplary embodiments described above. This may be done without departing from the spirit of the invention. These exemplary embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method for adjusting the clock of a base transceiver station comprising the steps of:
relating the base transceiver station's current time to a common time reference;
providing the base transceiver station with an offset based on the relation; and
adjusting the base transceiver station's clock based on the offset.

2. The method of claim 1, further comprising the steps of:
measuring the time of base transceiver stations surrounding the base transceiver station; and
measuring the time of the base transceiver station's clock.

3. The method of claim 2, further comprising the steps of:
providing a frame number and approximate control channel position of base transceiver stations surrounding the base transceiver station, wherein the time of base transceiver stations surrounding the base transceiver station and the time of the base transceiver station's clock are measured using the frame number and approximate control channel position.

4. The method of claim 3, wherein the frame number is transmitted in a broadcast control channel and the approximate control channel position is a position of a shared control channel.

5. The method of claim 2, wherein the base transceiver station is provided with information from a location measurement unit, wherein the base transceiver station's clock is adjusted based upon the information from the location measurement unit.

6. The method of claim 5, wherein the location measurement unit is associated with the base transceiver station.

7. The method of claim 5, wherein the location measurement unit is associated with another base transceiver station, wherein the another base transceiver station is within radio range of the base transceiver station.

8. The method of claim 5, wherein the information contains an indication of the accuracy of the clock of a base transceiver station used for generating the information.

9. The method of claim 1, wherein if the common time reference is not available, another base transceiver station's clock is used as the common time reference.

10. The method of claim 9, wherein the another base transceiver station's clock is used for synchronization of equipment co-sited with the base transceiver station.

11. The method of claim 1, further comprising the steps of:
determining global positioning satellite (GPS) time; and
comparing the GPS time to the time of the base transceiver station's clock, wherein the base transceiver station's clock is adjusted based upon the offset and the comparison.

12. The method of claim 11, further comprising the step of:
providing assistance data for decoding the chip sequence of a GPS signal.

13. The method of claim 11, wherein the GPS time is determined by examining messages of a GPS signal.

14. The method of claim 1, wherein the offset is provided by a serving mobile location center.

15. A system comprising:
means for relating the base transceiver station's current time to a common time reference;
means for providing the base transceiver station with an offset based on the relation; and
means for adjusting the base transceiver station's clock based on the offset.

16. The system of claim 15, further comprising:
means for measuring the time of base transceiver stations surrounding the base transceiver station; and
means for measuring the time of the base transceiver station's clock.

17. The system of claim 16, further comprising:
means for providing a frame number and approximate control channel position of base transceiver stations surrounding the base transceiver station, wherein the time of base transceiver stations surrounding the base transceiver station and the time of the base transceiver station's clock are measured using the frame number and approximate control channel position.

18. The system of claim 17, wherein the frame number is transmitted in a broadcast control channel and the approximate control channel position is a position of a shared control channel.

19. The system of claim 16, wherein the base transceiver station is provided with information from a location measurement unit, wherein the base transceiver station's clock is adjusted based upon the information from the location measurement unit.

20. The system of claim 19, wherein the location measurement unit is associated with the base transceiver station.

21. The system of claim 19, wherein the location measurement unit is associated with another base transceiver station, wherein the another base transceiver station is within radio range of the base transceiver station.

22. The system of claim 19, wherein the information contains an indication of the accuracy of the clock of a base transceiver station used for generating the information.

23. The system of claim 15, wherein if the common time reference is not available, another base transceiver station's clock is used as the common time reference.

24. The system of claim 23, wherein the another base transceiver station's clock is used for synchronization of equipment co-sited with the base transceiver station.

25. The system of claim 15, further comprising:
means for determining global positioning satellite (GPS) time; and
means for comparing the GPS time to the time of the base transceiver station's clock, wherein the base transceiver station's clock is adjusted based upon the offset and the comparison.

26. The system of claim 25, further comprising:
means for providing assistance data for decoding the chip sequence of a GPS signal.

27. The system of claim 25, wherein the GPS time is determined by examining messages of a GPS signal.

28. The system of claim 15, wherein the offset is provided by a serving mobile location center.

29. A radio network comprising:
a base transceiver station including a clock;
a location measurement unit;
wherein the location measurement station provides information regarding a current common time reference and wherein the clock is adjusted based upon the information.

30. The radio network of claim 29, further comprising:
another base transceiver station, wherein the location measurement unit is associated with the another base transceiver station.

31. The radio network of claim 30, wherein the information contains an indication of the accuracy of the clock of a base transceiver station used for generating the information.

32. The radio network of claim 29, further comprising:
another base transceiver station; and
another location measurement unit, wherein if the location measurement unit is not operative, the base transceiver station's clock is adjusted using information provided by the another location measurement unit.

33. The radio network of claim 32, wherein the location measurement unit and the another location measurement unit include a GPS receiver.

34. The radio network of claim 29, wherein the common time reference is global positioning satellite (GPS) time.
